(19) United States
(12) Patent Application Publication
(10) Pub. No.: US 2003/0136351 A1
(43) Pub. Date: Jul. 24, 2003

(54) Walkway device for permitting a pet ready access to both the inside and the outside of a home

(76) Inventor: Christine D. Morgan, Browntown, WI (US)

Correspondence Address: DAVID J. ARCHER, 9790 FOREST PRESERVE RD., DURAND, IL, 61024, US

(21) Appl. No.: 10/054,177

(22) Filed: Jan. 19, 2002

(51) Int. Cl. A01K 1/03; A01K 1/035; E06B 7/28

(52) U.S. Cl. 119/484

(57) ABSTRACT

A walkway device is disclosed for permitting a pet ready access to both an inside and an outside of a home. The device includes a plurality of tubular members disposed on the outside of the home for the passage therethrough of the pet. Each member has a first and a second extremity, the members being interconnected such that the first extremity of each member is connected to a second extremity of an adjacent member so that the members define a circuit for confining the pet. The arrangement is such that the pet is permitted to move in a first direction through the circuit and to move in a second direction through the circuit, the second direction being opposite to the first direction. One of the plurality of members defines an opening disposed between the first and second extremity thereof and a pet door is sealingly connected to the opening. The arrangement is such that the pet is permitted to freely enter and leave the home through the pet door and to move through the members without any possibility of the pet escaping, becoming lost or being attacked while outside the home. The device also inhibits anything other than the pet from gaining access into the home through the pet door.

### BACKGROUND OF THE INVENTION

1. Field of the Invention

The present invention relates to a walkway device for permitting a pet ready access to both the inside and the outside of a home. More specifically, the present invention relates to a walkway device for permitting a cat ready access to both the inside and the outside of a home.

2. Background Information

Many pet owners have constructed pet doors in order to allow their pet to gain access to the outside of an apartment or the like. However, there is the ever present danger that the pet will run off and be hurt by nearby traffic. Also, the pet may be attacked by other animals in the neighborhood or the pet may catch wild birds and bring the same into the owner's home.

Furthermore, many pet owners live in high rise apartments and only have relatively small patio areas for running their pet and there is a danger of their pet cat or dog falling from the patio.

The present invention overcomes all of the aforementioned problems by the provision of an easily assembled outside pet walkway which confines movement of the pet while enabling the pet to exercise outside.

Therefore, it is a primary feature of the present invention to provide a walkway device that overcomes the problems associated with the prior art arrangements.

Another feature of the present invention is the provision of a walkway device that enables a pet to have ready access to both the inside and outside of a home.

A further feature of the present invention is the provision of a walkway device that protects the pet from attack by stray animals.

Another feature of the present invention is the provision of a walkway device that prevents loss of the pet when outside the home.

Another feature of the present invention is the provision of a walkway device that overcomes the problem of access by stray animals into the home through the pet door.

Other features and advantages of the present invention will be readily apparent to those skilled in the art by a consideration of the detailed description of a preferred embodiment of the present invention contained herein.

### SUMMARY OF THE INVENTION

The present invention relates to a walkway device for permitting a pet ready access to both an inside and an outside of a home. The device includes a plurality of tubular members disposed on the outside of the home for the passage therethrough of the pet. Each member has a first and a second extremity, the members being interconnected such that the first extremity of each member is connected to a second extremity of an adjacent member so that the members define a circuit for confining the pet. The arrangement is such that the pet is permitted to move in a first direction through the circuit and to move in a second direction through the circuit, the second direction being opposite to the first direction. One of the plurality of members defines an opening disposed between the first and second extremity thereof and a pet door is sealingly connected to the opening. The arrangement is such that the pet is permitted to freely enter and leave the home through the pet door and to move through the members without any possibility of the pet escaping, becoming lost or being attacked while outside the home. The device also inhibits anything other than the pet from gaining access into the home through the pet door.

In a more specific embodiment of the present invention, the plurality of tubular members are fabricated from a plastics material.

Also, each tubular member includes a base having a first and a second surface and a first and a second side and a first and second end. Additionally, each tubular member includes a cover of inverted U-shaped cross-sectional configuration, the cover having a first and a second end, the cover cooperating with the base to define therebetween a passage for the movement therethrough of the pet.

More particularly, the base defines a plurality of apertures for drainage therethrough of water.

The base includes a plurality of spaced blocks secured to the first surface of the base, the blocks permitting the pet to move along the tubular member between the first and second extremities thereof particularly when the member is inclined between the extremities thereof.

Additionally, the base includes a tab extending from the first side of the base, the tab defining a bore. The base also includes a further tab extending from the second side of the base, the further tab defining a further bore. An anchor cooperates with the bore for anchoring the base and a further anchor cooperates with the further bore for anchoring the base.

In one embodiment of the present invention, the anchors are inverted U-shaped tie downs for anchoring the base to the ground.

In another embodiment of the present invention, the anchor is an extendable hooked cord having a first and a second hook so that the first hook cooperates with the bore and the second hook cooperates with the further bore, the cord extending around a patio fence rail for anchoring the base to the patio fence rail.

Moreover, the base defines a hooked extension extending from the second end of the base and the base defines a slot disposed adjacent to the first end of the base for engaging a hooked extension of an adjacent base for interlocking each base with an adjacent base.

The cover includes a plurality of catches and the base defines a plurality of orifices, each orifice being aligned relative to a corresponding catch. The arrangement is such that each catch is received within an orifice so that the cover and base are locked together when the catches are urged into engagement with the orifices.

Also, the cover defines a plurality of perforations which are preferably lattice style for permitting the pet to see out of the tubular member.

Additionally, the cover includes a plurality of curved hooks which extend from the second end of the cover and the cover defines a plurality of recesses disposed adjacent to the first end of the cover. Each recess is aligned with a curved hook of an adjacent cover so that interlocking of adjacent covers is permitted.

The one of the plurality of members includes a plurality of fasteners surrounding the opening for fastening the one member relative to the pet door. Each fastener of the plurality of fasteners includes an interlocking hook and eye disposed in aligned relationship on the one member and the pet door for sealingly connecting the opening relative to the pet door.

In a preferred embodiment of the present invention, the one of the plurality of members is of Y-shaped configuration in plan view.

Furthermore, a further one of the tubular members is of flexible accordion type construction for permitting adjacent tubular members to be disposed offset relative to each other.

The pet door includes an extension for sealingly connecting the pet door to the opening. More specifically, the extension includes a further plurality of tubular members disposed on the outside of the home for the passage therethrough of the pet. Each member of the further plurality of members has a first and a second extremity, the members being interconnected such that the first extremity of each member is connected to a second extremity of an adjacent member so that the members define a passageway for confining the pet so that the pet is permitted to move between the pet door and the opening. Moreover, the members of the further plurality of members are interchangeable with members defining the circuit.

Many modifications and variations of the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

### BRIEF DESCRIPTION OF THE DRAWINGS

FIG. 1 is a perspective view of a maze type walkway device according to the present invention;

FIG. 2 is an enlarged perspective view of one of the tubular members shown in FIG. 1 that make up the maze or circuit;

FIG. 3 is a plan view of the base shown in FIG. 2;

FIG. 4 is a perspective view of the base shown in FIG. 3;

FIG. 5 is a fragmentary perspective view showing more specifically details of a fastening device of one of the members shown in FIG. 2;

FIG. 6 is an enlarged perspective view of a connecting member shown in FIG. 1;

FIG. 7 is an enlarged perspective view of the pet door from the outside shown in FIG. 1;

FIG. 8 is a plan view of the base of the member shown in FIG. 6;

FIG. 9 is a perspective view of a flexible or accordion style tubular member;

FIG. 10 is a perspective view showing how particularly with the use of the member shown in FIG. 9, to show how the members can be supported on poles or elevated by securing the circuit to many types of bases, trees and the like;

FIG. 11 is a perspective view of a portion of the walkway device according to the present invention for attachment to a hand rail of a flight of steps;

FIG. 12 is a sectional view taken on the line 12-12 of FIG. 7; and

FIG. 13 is a perspective view of the pet door shown in FIG. 1 but viewed from inside.

Similar reference characters refer to similar parts throughout the various views and embodiments of the present invention.

### DETAILED DESCRIPTION OF THE DRAWINGS

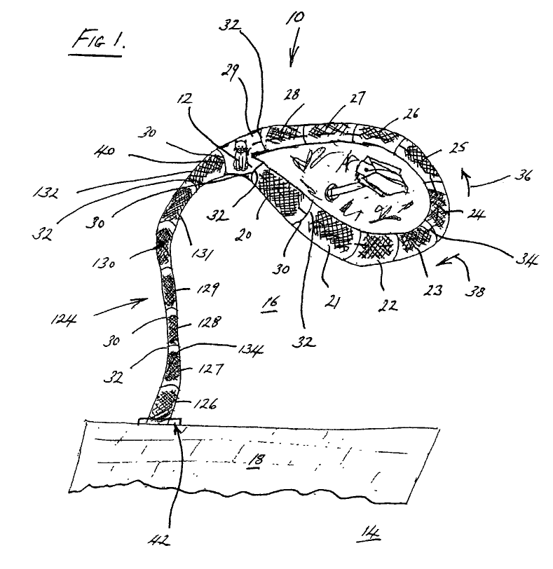

FIG. 1 is a perspective view of a walkway device generally designated 10 according to the present invention for permitting a pet 12 ready access to both an inside 14 and an outside 16 of a home 18. The device 10 includes a plurality of tubular members 20, 21, 22, 23, 24, 25, 26, 27, 28 and 29 disposed on the outside 16 of the home 18 for the passage therethrough of the pet 12. Each member such as 20 has a first and a second extremity 30 and 32 respectively, the members 20-29 being interconnected such that the first extremity 30 of each member such as 20 is connected to a second extremity 32 of an adjacent member 21 so that the members 20-29 define a circuit 34 as indicated by the broken line for confining the pet 12. The arrangement is such that the pet 12 is permitted to move in a first direction as indicated by the arrow 36 through the circuit 34 and to move in a second direction as indicated by the arrow 38 through the circuit 34, the second direction 38 being opposite to the first direction 36. One of the members 29 of the plurality of members 20-29 defines an opening 40 disposed between the first and second extremity 30 and 32 thereof. A pet door generally designated 42 is sealingly connected to the opening 40. The arrangement is such that the pet 12 is permitted to freely enter and leave the home 18 through the pet door 42 and to move through the members 20-29 without any possibility of the pet 12 escaping, becoming lost or being attacked while outside the home 18. The device 10 also inhibits anything other than the pet 12 from gaining access into the home 18 through the pet door 42 and inhibits the pet from catching insects, birds or rodents and bringing them inside.

In a more specific embodiment of the present invention, the plurality of tubular members 20-29 are fabricated from a plastics material.

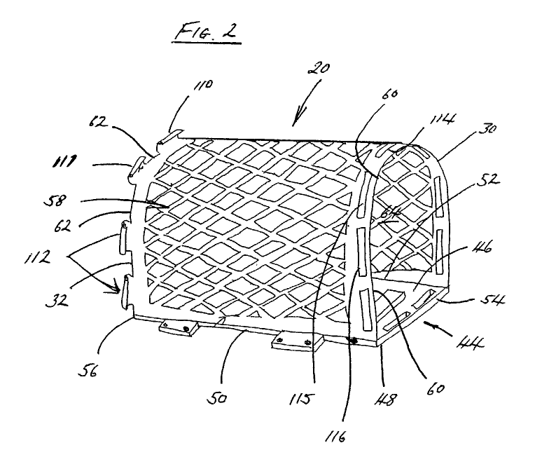

FIG. 2 is an enlarged perspective view of one of the members 20-29 such as member 20. As shown in FIG. 2, each tubular member 20-29 such as 20 includes a base generally designated 44 having a first and a second surface 46 and 48 respectively and a first and a second side 50 and 52 respectively and a first and second end 54 and 56 respectively. Additionally, each tubular member such as member 20 includes a cover generally designated 58 which may be manufactured flat. The cover 58 is of inverted U-shaped cross-sectional configuration. The cover 58 has a first and a second end 60 and 62 respectively, the cover 58 cooperating with the base 44 to define therebetween a passage 64 for the passage therethrough of the pet 12.

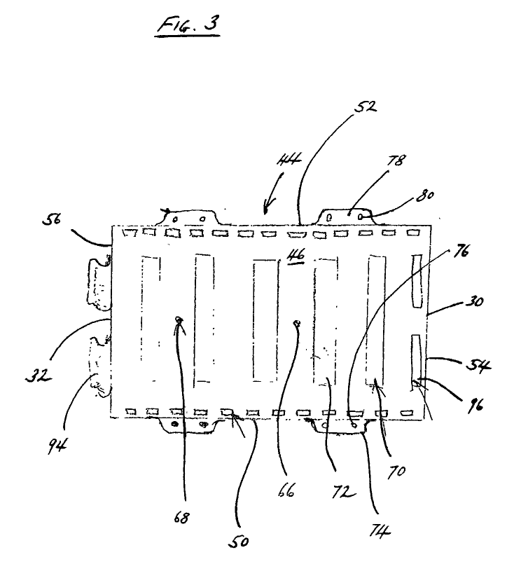

FIG. 3 is a plan view of the base 44 shown in FIG. 2. As shown in FIG. 3, the base 44 defines a plurality of apertures or holes or round openings 66 and 68 respectively for drainage therethrough of water or any liquid.

The base 44 includes a plurality of spaced blocks 70 and 72 respectively secured to the first surface 46 of the base 44. The blocks 70 and 72 could be raised areas molded into the surface 46 for permitting the pet 12 to move along the tubular member 20 between the first and second extremities 30 and 32 thereof particularly when the member 20 is inclined between the extremities 30 and 32 thereof.

Additionally, the base 44 includes a tab 74 extending from the first side 50 of the base 44, the tab 74 defining a bore 76. The base 44 also includes a further tab 78 extending from the second side 52 of the base 44, the further tab 78 defining a further bore 80.

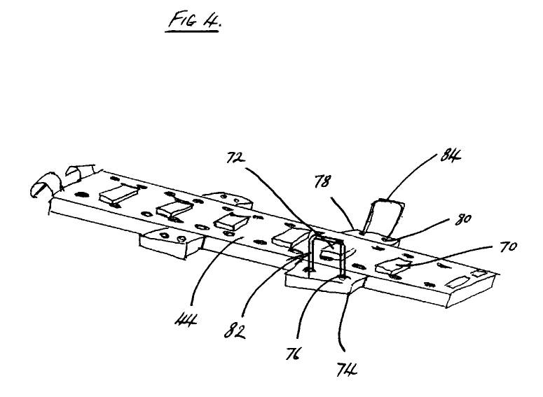

FIG. 4 is a perspective view of the base 44 shown in FIG. 3. As shown in FIG. 4, an anchor generally designated 82 cooperates with the bore 76 for anchoring the base 44 and a further anchor 84 cooperates with the further bore 80 for anchoring the base 44.

In one embodiment of the present invention, the anchors 82 and 84 are inverted U-shaped tie downs for anchoring the base 44 to the ground.

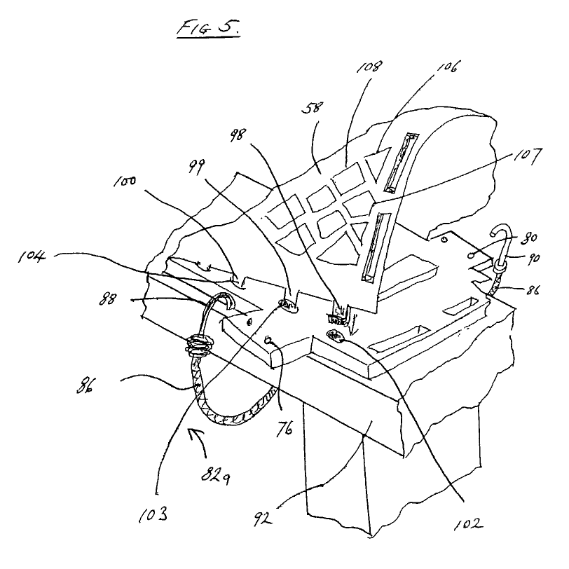

FIG. 5 is a fragmentary perspective view showing another embodiment of the present invention. As shown in FIG. 5, the anchor 82a is an extendable hooked cord 86 having a first and a second hook 88 and 90 so that the first hook 88 cooperates with the bore 76 and the second hook 90 cooperates with the further bore 80, the cord 86 extending under a patio fence rail 92 for anchoring the base 44 to the patio fence rail 92.

As shown in FIG. 3, the base 44 defines a hooked extension 94 extending from the second end 56 of the base 44 and the base 44 defines a slot 96 disposed adjacent to the first end 54 of the base 44 for engaging a hooked extension 94 of an adjacent base 44 of the member 21 for interlocking each base 44 with an adjacent base.

As shown in FIG. 5, the cover 58 includes a plurality of catches 98, 99 and 100 and the base 44 defines a plurality of orifices 102, 103 and 104 respectively, each orifice such as 102 being aligned relative to a corresponding catch 98. The arrangement is such that each catch 98-100 is received within an orifice 102-104 so that the cover 58 and base 44 are locked together when the catches 98-100 are urged into engagement with the orifices 102-104.

Also, the cover 58 defines a plurality of perforations 106, 107 and 108 respectively which may be lattice style openings for permitting the pet 12, open to the elements, to see out of the tubular member 20.

As shown in FIG. 2, the cover 58 includes a plurality of curved hooks 110, 111 and 112 respectively which extend from the second end 62 of the cover 58 and the cover 58 defines a plurality of recesses 114, 115 and 116 respectively disposed adjacent to the first end 60 of the cover 58. Each recess 114-116 is aligned with a curved hook 110-112 of an adjacent cover 58 of an adjacent member such as 21 so that interlocking of adjacent covers is permitted.

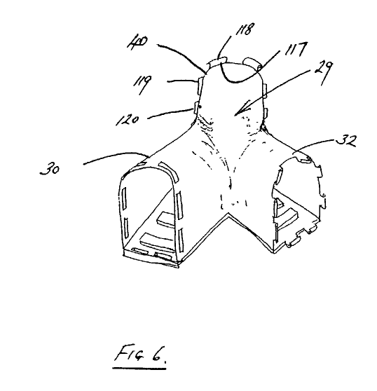

FIG. 6 is an enlarged perspective view of the member 29 of the plurality of members 20-29 shown in FIG. 1. As shown in FIG. 6, the member 29 includes a plurality of fasteners 118, 119 and 120 surrounding the opening 40 for connecting the one member 29 to the pet door 42.

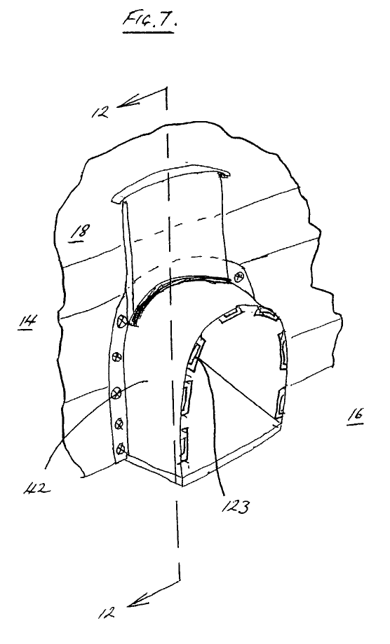

FIG. 7 is an enlarged perspective outside view of the pet door 42. As shown in FIGS. 6 and 7, each fastener such as 118 of the plurality of fasteners 118-120 includes an interlocking hook 117 and eye 123 disposed in aligned relationship on the one member 29 and the pet door 42 for sealingly connecting the opening 40 relative to the pet door 42.

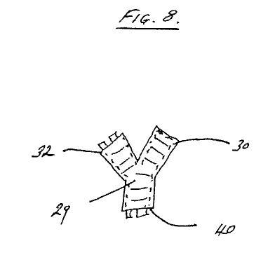

FIG. 8 is a plan view of the base of the Y-shaped member 29 shown in FIG. 6. As shown in FIG. 8, the one member 29 of the plurality of members 20-29 is of Y-shaped configuration in plan view.

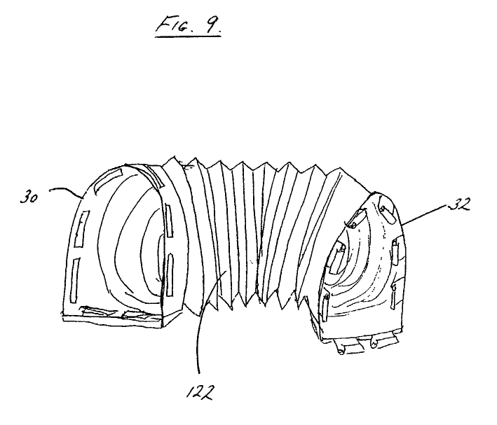

FIG. 9 is a perspective view of a further one 122 of the tubular members. As shown in FIG. 9, the further one 122 of the tubular members is of flexible accordion type construction for permitting adjacent tubular members to be disposed offset relative to each other.

As shown in FIG. 1, the pet door 42 includes an extension generally designated 124 for sealingly connecting the pet door 42 to the opening 40. More specifically, the extension 124 includes a further plurality of tubular members 126, 127, 128, 129, 130, 131 and 132 disposed on the outside 16 of the home 18 for the passage therethrough of the pet 12. Each member such as 128 of the further plurality of members 126-132 has a first and a second extremity 30 and 32 respectively, the members 126-132 being interconnected such that the first extremity 30 of each member is connected to a second extremity 32 of an adjacent member so that the members 126-132 define a passageway 134 for confining the pet 12 so that the pet 12 is permitted to move between the pet door 42 and the opening 40. Moreover, the members 126-132 of the further plurality of members are interchangeable with members 20-28 defining the circuit 34.

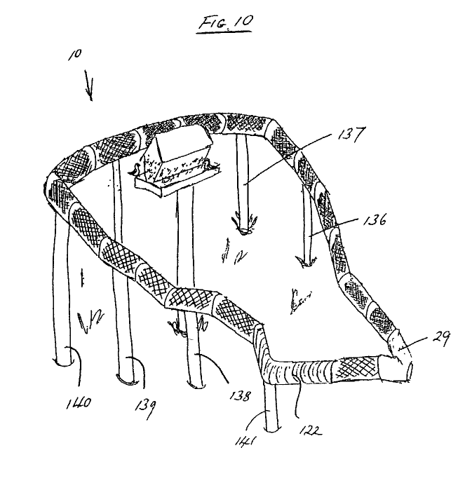

FIG. 10 is a perspective view showing how particularly with the use of the accordion type member 122 shown in FIG. 9, the members can be supported on poles 136, 137, 138, 139 and 140 with the accordion type member 122 supported on pole 141 so that the walkway device 10 is raised from the ground without any danger of the pet 12 such as a cat endangering a bird on a feed table or the like.

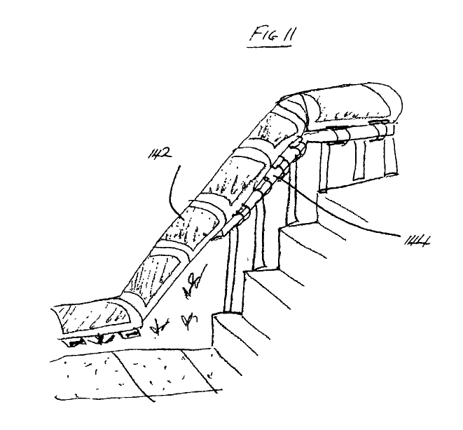

FIG. 11 is a perspective view of a portion of the walkway device according to the present invention for attachment to a hand rail 144 of a flight of steps.

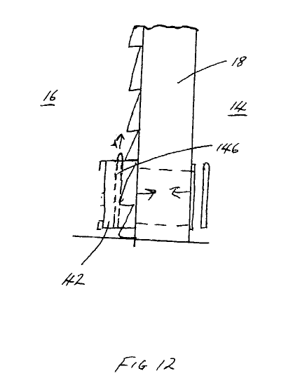

FIG. 12 is a sectional view taken on the line 12-12 of FIG. 7. As shown in FIG. 12, the pet door 42 is of tunnel shaped configuration. The pet door 42 extends through the outside wall of the home 18 and includes a closable slide 146.

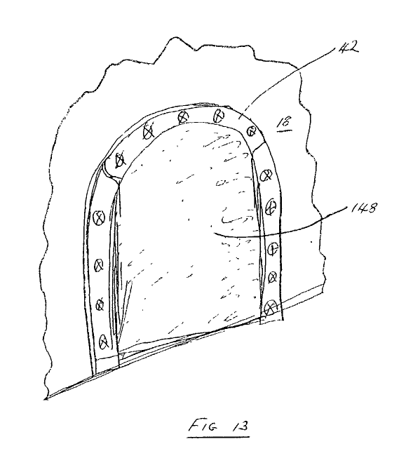

FIG. 13 is a perspective view of the pet door shown in FIG. 1 but viewed from inside. As shown in FIG. 13, the pet door 42 includes a flap 148 of clear plastic material.

In operation of the device 10 according to the present invention, the pet door is secured through the outside wall of the home 18. The pet door 42 may be secured through an existing outside door of the home or through a window of the home. The tubular members are then interlocked to the pet door 42 and are secured to the ground or are anchored to a patio rail, handrail or posts in a desired configuration according to the existing outside layout of the home 18 or owner's property or yard. The Y-shaped member 29 can be attached at any location to an adjacent member so that a circuit 34 can be built from further interlocking tubular members. Although in the drawings a single member 29 is used to connect the passageway 134 with the circuit 34, it will be appreciated that several members 29 can be provided with a corresponding number of circuits thus making a pet maze according to the available outside space and the desired extent of the walkway device. Those skilled in the art will appreciate that a multitude of combinations and configurations of the walkway device are possible within the scope of the present invention as defined by the following claims. Also, it will be appreciated that the present invention provides numerous arrangements and flexibility particularly by the provision of the flexible accordion type members 122 shown in FIG. 9 and that each of the members 20-28 and 126-132 and 122 is interchangeable.

The present invention provides a unique pet walkway which permits the pet to gain access to the outside without any fear of the pet becoming lost or attacked by neighbor dogs or cats. The present invention also stops the pet from endangering wild birds or the like and prevents anything but the pet from gaining access into the home through the pet door.

What is claimed is:

1. A walkway device for permitting a pet ready access to both an inside and an outside of a home, said device comprising:
a plurality of tubular members disposed on the outside of the home for the passage therethrough of the pet, each member of said plurality of members having a first and a second extremity, said members being interconnected such that said first extremity of each member is connected to a second extremity of an adjacent member so that said members define a circuit for confining the pet so that the pet is permitted to move in a first direction through said circuit and to move in a second direction through said circuit, said second direction being opposite to said first direction;
one of said plurality of members defining an opening between said first and second extremity thereof; and
a pet door sealingly connected to said opening, the arrangement being such that the pet is permitted to freely enter and leave the home through said pet door and to move through said members without any possibility of the pet escaping, becoming lost or being attacked while outside the home, said device also inhibiting anything other than the pet from gaining access into the home through said pet door.

2. A walkway device as set forth in claim 1 wherein
said plurality of tubular members are fabricated from a plastics material.

3. A walkway device as set forth in claim 1 wherein
each tubular member includes:
a base having a first and a second surface and a first and a second side and a first and second end;
a cover of inverted U-shaped cross-sectional configuration, said cover having a first and a second end, said cover cooperating with said base to define therebetween a passage for the passage therethrough of the pet.

4. A walkway device as set forth in claim 3 wherein
said base defines a plurality of apertures for drainage therethrough of water.

5. A walkway device as set forth in claim 3 wherein
said base includes:
a plurality of spaced blocks secured to said first surface of said base, said blocks permitting the pet to move along said tubular member between said first and second extremities thereof particularly when said member is inclined between said extremities thereof.

6. A walkway device as set forth in claim 3 wherein
said base includes:
a tab extending from said first side of said base, said tab defining a bore;
a further tab extending from said second side of said base, said further tab defining a further bore;
an anchor cooperating with said bore for anchoring said base;
a further anchor cooperating with said further bore for anchoring said base.

7. A walkway device as set forth in claim 6 wherein
said anchors are inverted U-shaped tie downs for anchoring said base to the ground.

8. A walkway device as set forth in claim 6 wherein
said anchor is an extendable hooked cord having a first and a second hook so that said first hook cooperates with said bore and said second hook cooperates with said further bore, said cord extending around a patio fence rail for anchoring said base to the patio fence rail.

9. A walkway device as set forth in claim 3 wherein
said base defines a hooked extension extending from said second end of said base;
said base defines a slot disposed adjacent to said first end of said base for engaging a hooked extension of an adjacent base for interlocking each base with an adjacent base;

10. A walkway device as set forth in claim 3 wherein
said cover includes:
a plurality of catches;
said base defining a plurality of orifices, each orifice being aligned relative to a corresponding catch so that each of catch is received within an orifice so that said cover and base are locked together when said catches are urged into engagement with said orifices.

11. A walkway device as set forth in claim 3 wherein
said cover defines a plurality of perforations for permitting the pet to see out of said tubular member.

12. A walkway device as set forth in claim 3 wherein
said cover includes:
a plurality of curved hooks extending from said second end of said cover;
said cover defining a plurality of recesses disposed adjacent to said first end of said cover, each recess being aligned with a curved hook of an adjacent cover so that interlocking of adjacent covers is permitted.

13. A walkway device as set forth in claim 1 wherein
said one of said plurality of members includes:
a plurality of fasteners surrounding said opening for fastening said one member relative to said pet door.

14. A walkway device as set forth in claim 13 wherein
each fastener of said plurality of fasteners includes:
an interlocking hook and eye disposed in aligned relationship on said one member and said pet door for sealingly connecting said opening relative to said pet door.

15. A walkway device as set forth in claim 1 wherein
said one of said plurality of members is of Y-shaped configuration in plan view.

16. A walkway device as set forth in claim 1 wherein
a further one of said tubular members is of flexible accordion type construction for permitting adjacent tubular members to be disposed offset relative to each other.

17. A walkway device as set forth in claim 1 wherein
said pet door includes:
an extension for sealingly connecting said pet door to said opening.

18. A walkway device as set forth in claim 17 wherein
said extension includes:
a further plurality of tubular members disposed on the outside of the home for the passage therethrough of the pet, each member of said further plurality of members having a first and a second extremity, said members being interconnected such that said first extremity of each member is connected to a second extremity of an adjacent member so that said members define a passageway for confining the pet so that the pet is permitted to move between said pet door and said opening, said members of said further plurality of members being interchangeable with members defining said circuit.

19. A walkway device for permitting a cat ready access to both an inside and an outside of a home, said device comprising:
a plurality of tubular members disposed on the outside of the home for the passage therethrough of the pet, each member of said plurality of members having a first and a second extremity, said members being interconnected such that said first extremity of each member is connected to a second extremity of an adjacent member so that said members define a circuit for confining the cat so that the cat is permitted to move in a first direction through said circuit and to move in a second direction through said circuit, said second direction being opposite to said first direction;
one of said plurality of members defining an opening between said first and second extremity thereof, and
a cat door sealingly connected to said opening, the arrangement being such that the cat is permitted to freely enter and leave the home through said cat door and to move through said members without any possibility of the cat escaping, becoming lost or being attacked while outside the home, said device also inhibiting anything other than the cat from gaining access into the home through said cat door.

20. A walkway device for permitting a pet ready access to both an inside and an outside of a home, said device comprising:
a plurality of tubular members disposed on the outside of the home for the passage therethrough of the pet, each member of said plurality of members having a first and a second extremity, said members being interconnected such that said first extremity of each member is connected to a second extremity of an adjacent member so that said members define a circuit for confining the pet so that the pet is permitted to move in a first direction through said circuit and to move in a second direction through said circuit, said second direction being opposite to said first direction;
one of said plurality of members defining an opening between said first and second extremity thereof;
a pet door sealingly connected to said opening, the arrangement being such that the pet is permitted to freely enter and leave the home through said pet door and to move through said members without any possibility of the pet escaping, becoming lost or being attacked while outside the home, said device also inhibiting anything other than the pet from gaining access into the home through said pet door;
said pet door including:
an extension for sealingly connecting said pet door to said opening; and
said extension including:
a further plurality of tubular members disposed on the outside of the home for the passage therethrough of the pet, each member of said further plurality of members having a first and a second extremity, said members being interconnected such that said first extremity of each member is connected to a second extremity of an adjacent member so that said members define a passageway for confining the pet so that the pet is permitted to move between said pet door and said opening, said members of said further plurality of members being interchangeable with members defining said circuit.
